(19) United States
(12) Patent Application Publication
(10) Pub. No.: US 2008/0134572 A1
(43) Pub. Date: Jun. 12, 2008

(54) Method for Making a Combustible Fuel Composition

(76) Inventor: Bao Tai Cui, Jincheng Shanxi (CN)

Correspondence Address: ELEY LAW FIRM CO., 7870 OLENTANGY RIVER RD, SUITE 311, COLUMBUS, OH, 43235, US

(21) Appl. No.: 11/951,401

(22) Filed: Dec. 6, 2007

Related U.S. Application Data
(60) Provisional application No. 60/868,796, filed on Dec. 6, 2006.

(51) Int. Cl. C10L 9/00; B05D 3/02

(52) U.S. Cl. 44/542; 427/314

(57) ABSTRACT

A method for making a combustible fuel composition. At least one core component is granulated to a predetermined range of granule sizes. A metered portion of the granulated core component is formed into a generally planar core portion having a predetermined size and shape. A liquefied accelerant component is provided, and the core portion is at least partially immersed into the accelerant component such that the accelerant component at least one of coats the core portion and is absorbed by the core portion, thereby forming a briquette.

This application claims priority to U.S. provisional patent application No. 60/868,796, filed Dec. 6, 2006, the entire contents of which are hereby incorporated by reference thereto.

### FIELD

The present invention relates generally to combustible fuels, in particular to a method for making a combustible fuel briquette.

### BACKGROUND

Many efforts have been made to produce fuels for barbecuing that are clean-burning, easy to handle, and easily ignitable. Charcoal, usually made from a wood base, is the most common component of fuels for barbecuing. Charcoals having vegetable and coal bases have also been used. Such fuels are usually difficult to ignite and often require the use of an ancillary flammable material, such as lighter fluid or newspaper, to create a flame of sufficient intensity and duration to ignite the charcoal.

Previous efforts to make charcoal fuel easier to ignite have involved the impregnation of charcoal with a more flammable “starting” compound, such as lighter fluid (or other volatile fluids, such as higher alkanes), waxes, or other oxidants that burn faster and more readily than charcoal. However, these materials penetrate only the outer surface of the charcoal. In addition, accelerants such as wax are typically distilled from a petroleum base and thus are not considered environmentally friendly. Furthermore, starting compounds typically include volatile components that are easily oxidized or are susceptible to dissipation over time, reducing the effectiveness of those fuels. Other efforts to make charcoal easier to ignite involve a mixture of charcoal and an ignitable material, ultimately forming a homogeneous material that, overall, should be easier to burn. The goal, however, of utilizing an easily ignitable material is to achieve the initial burning of the charcoal so that, once the charcoal reaches a certain level of combustion, it burns without further aid. Accordingly, mixing the ignitable component throughout the fuel adds little overall benefit because the benefits of ancillary ignitable components are superfluous once the combustion of the charcoal is underway. In addition, the use of volatile or easily combustible components throughout such fuels produces fumes during combustion, which may impart undesirable odors and flavors to food cooked using such an article. Such fumes are typically given off during the entire burning time, which is a considerable drawback.

Another consideration for combustible fuel is efficient burning. Some fuels release a large amount of heat during the initial stages of combustion, then taper off to a much lower release rate during the time appropriate for cooking. It would be more efficient, and perhaps safer, to have a fuel having a heat release rate during ignition that is intense and which then tapers off quickly upon complete ignition of the briquette. In this way, less heat generated by a fuel would be wasted in the startup process and could be utilized in the form of longer cooking times.

The present inventor has addressed many of the foregoing issues in his U.S. Pat. No. 7,022,147, the entire contents of which are hereby incorporated by reference thereto. However, there are additional areas of concern in the art that need to be addressed. In particular, so-called “instant-lighting” charcoal briquette fuels typically comprise various combinations of barium nitrate, sodium nitrate (nitrate-sort), wood charcoal, anthracite coal and a binder which act as an ignition or “accelerant” layer. These materials can produce noxious fumes during combustion that contain heavy metals, which are known to be harmful to humans and the environment. A particular hazard is the potential for transfer of heavy metals from the fumes to foods cooked over the briquettes. Similarly, after the accelerant layer has combusted, the resulting ashes of the charcoal and anthracite on the surface of the briquette are very incompact and are thus easily rendered airborne by air moving across the briquettes. The ashes may come into contact with and contaminate foods cooked over the briquettes. Airborne ashes are also a source of environmental pollution.

Heavy metals may also be present in the ashes remaining after combustion of the briquettes. Improper disposal of the ashes, such as in a landfill or by dispersion on the ground, can result in soil contamination.

Another drawback of current combustible fuels is that the accelerant layer intended to ignite the charcoal often burns violently and intensely, potentially harming persons in proximity to the briquettes when they are combusting. Yet another shortcoming of current combustible fuels is that the accelerant layer has a relatively short shelf life once exposed to air, making the briquettes expensive to package such that unused portions of an opened package can be stored for a period of time prior to use without significant degradation.

As can be seen, there is a need for a cost-effective method of producing a combustible fuel that is more compatible with food cooked thereover, is environmentally-friendly, has a relatively low fire hazard and has an extended shelf life.

### SUMMARY

A method for making a combustible fuel briquette is disclosed according to an embodiment of the present invention. A core portion of the briquette is comprised of compounded organic components and is compacted to a predetermined shaped such as, for example, a generally planar plum blossom round shape having a plurality of vents extending therethrough. The core portion is at least partially immersed in a liquefied accelerant which is also comprised of a compound of organic materials, thereby forming an accelerant portion of the briquette. The organic briquette is compatible with food cooked thereover, is environmentally-friendly, has a reduced fire hazard and has an extended shelf life.

One aspect of the present invention is a method for making a combustible fuel composition. At least one core component is granulated to a predetermined range of granule sizes. A metered portion of the granulated core component is formed into a generally planar core portion having a predetermined size and shape. A liquefied accelerant component is provided, and the core portion is at least partially immersed into the accelerant component such that the accelerant component at least one of coats the core portion and is absorbed by the core portion, thereby forming a briquette.

Another aspect of the invention is method for making a combustible fuel composition that comprises the steps of granulating a plurality of solid core components to respective predetermined ranges of granule sizes, combining the granulated solid core components together, and stirring the combined solid core components. A liquefied core component is combined together with the combined solid core components. The combined solid and liquid core components are stirred. A metered portion of the combined solid and liquid core components is formed into a generally planar core portion having a predetermined size and shape. The core portion is then dried after forming. A liquefied accelerant component is provided in an immersion tank. The core portion is transported into the immersion tank by means of a conveyor belt, at least partially immersing the core portion in the accelerant component at a predetermined depth for a predetermined soaking time such that the accelerant component at least one of coats the core portion and is absorbed by the core portion, thereby forming a briquette. The briquette is transported out of the immersion tank by means of the conveyor belt and cooled.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a perspective view of a briquette according to an embodiment of the present invention;

FIG. 2 is top plan view of the briquette of FIG. 1;

FIG. 3 is a bottom plan view of the briquette of FIG. 1;

FIG. 4 is a view in section of the briquette of FIG. 1;

FIG. 5 shows the introduction of a core portion mixture into a molding device according to an embodiment of the present invention;

FIG. 6 shows compaction of the core mixture of FIG. 5 to form a core portion of a briquette according to an embodiment of the present invention;

FIG. 7 shows the ejection of a compacted, shaped core portion of a briquette from a mold according to an embodiment of the present invention;

FIG. 8 is a schematic diagram showing a method for combining a core portion of a briquette with an accelerant portion according to an embodiment of the present invention;

FIG. 9 is a flow diagram describing a method for producing briquettes according to an embodiment of the present invention;

FIG. 10 shows a method of using a briquette according to an embodiment of the present invention;

FIG. 11 is a top plan view of a briquette according to an alternate embodiment of the present invention;

FIG. 12 is a top plan view of a briquette according to another alternate embodiment of the present invention;

FIG. 13 is a top plan view of a briquette according to yet another alternate embodiment of the present invention;

FIG. 14 is a top plan view of a briquette according to still another alternate embodiment of the present invention;

FIG. 15 is a top plan view of a briquette according to yet another alternate embodiment of the present invention;

FIG. 16 is a top plan view of a briquette according to still another alternate embodiment of the present invention;

FIG. 17 is a perspective view of a briquette according to another alternate embodiment of the present invention;

FIG. 18 is top plan view of the briquette of FIG. 17;

FIG. 19 is a bottom plan view of the briquette of FIG. 17; and

FIG. 20 is a view in section of the briquette of FIG. 17.

### DETAILED DESCRIPTION

In the discussion that follows, like reference numerals are used to refer to like elements in the various figures.

### Structure

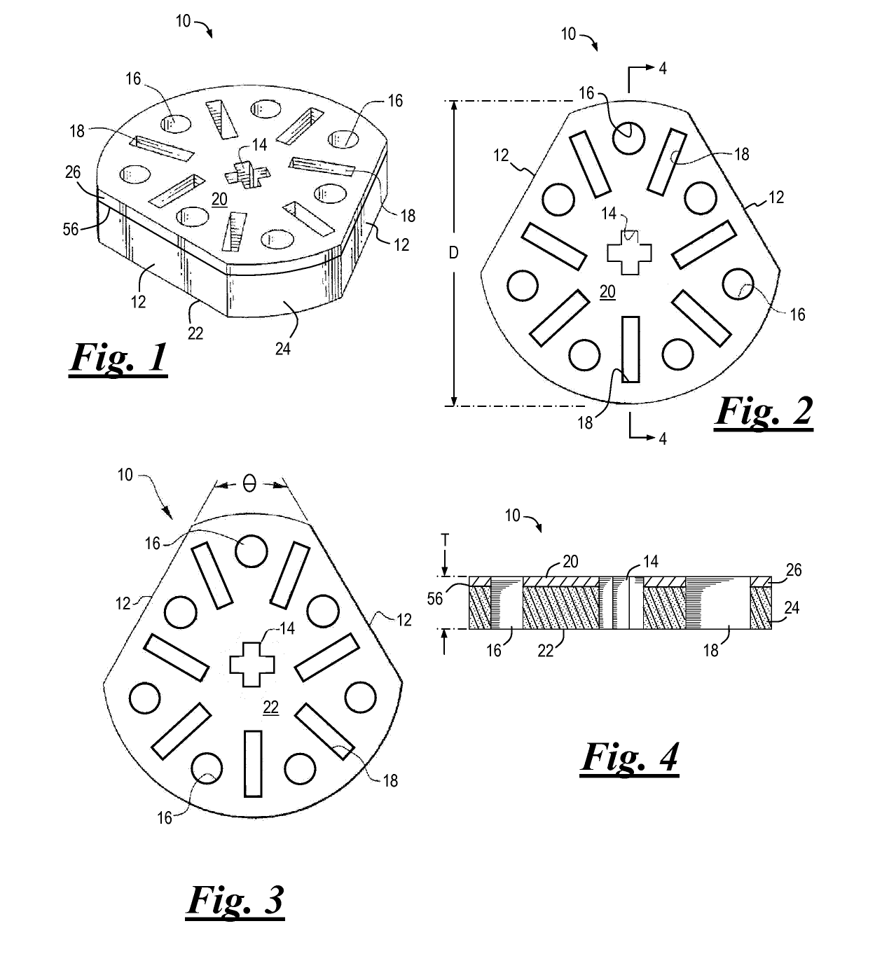

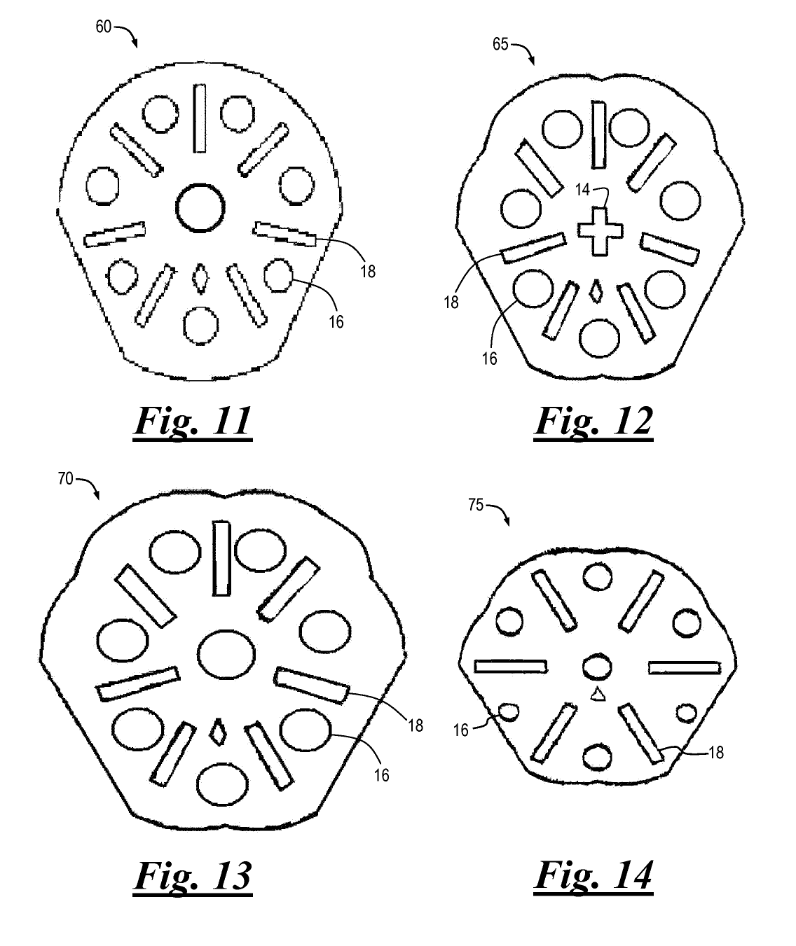

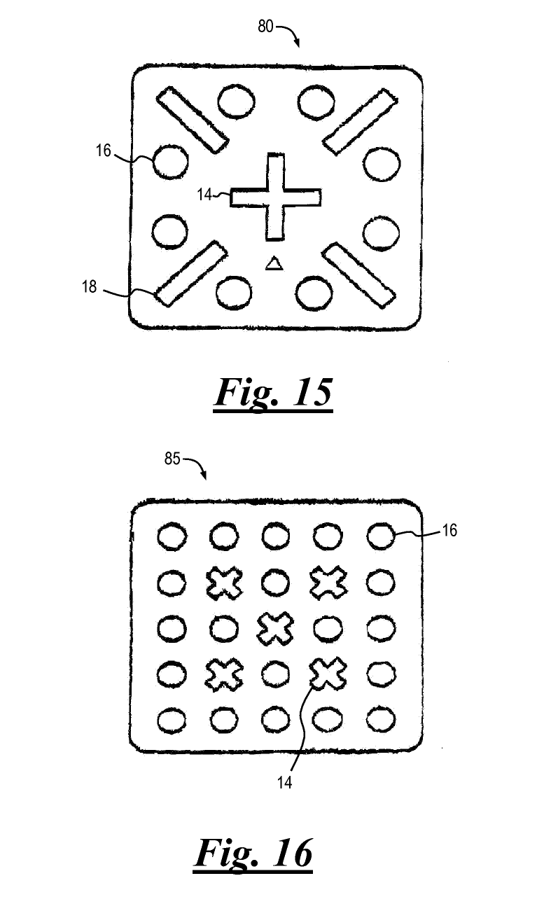

With reference to FIGS. 1-4 in combination, the general arrangement of a briquette 10 having a plurality of facets is shown according to an embodiment of the present invention. In this embodiment briquette 10 is generally planar and has a shape generally defined as a circle having a predetermined thickness “T” of about 3-5 cm, and a predetermined diameter “D” of about 12 cm from which two portions have been excised, forming sides 12. The sides, when extrapolated, form an included angle θ of about 30 degrees, as shown in FIG. 3. However, it should be noted that any or all of diameter D, thickness T and angle θ may be varied as desired for a particular configuration of briquette 10 without departing from the scope of the present invention. In addition, alternate embodiments of the present invention having different shapes are anticipated, such as briquettes 60, 65, 70, 75, 80 and 85 shown in FIGS. 11-16 respectively. Likewise, other planar geometric shapes of briquettes according to the present invention are anticipated by the inventor including, without limitation, circular, polygonal, trapezoidal, hexagonal, pentagonal, triangular, rectangular and octagonal shapes. Regardless of the shape formed, all briquettes described herein are considered to have, interchangeably, the same elements, features, structure and functions as briquette 10 except as detailed herein.

Briquette 10 may further include a generally centrally-located, cruciform-shaped vent 14, as well as a plurality of cylindrically-shaped vents 16 and rectangularly-shaped vents 18. Vents 14-18 extend between a top surface 20 and a bottom surface 22 of briquette 10. Vents 14-18 encourage air flow ventilation through and around briquette 10 for rapid, even burning and complete combustion, thus providing a clean, low-ash heat source. Vents 14-18 also provide for fast and generally uniform drying of briquette 10 during fabrication of the briquette, as further detailed below.

With reference to FIGS. 1-3, in one example embodiment of the present invention cruciform-shaped vent 14 is centrally located. Peripheral cylindrical vents 16 (having a diameter of about 12-15 mm) and peripheral elongated slot vents 18 (having dimensions of about 6-8 cm in length and about 3-4 cm in width) are arranged in an alternating pattern, extending radially outward from the cruciform-shaped aperture 14. The size, shape, number and locations of each of vents 14-18 may be varied as desired to form a predetermined pattern for a particular configuration of briquette 10. Non-limiting examples of alternate embodiments of briquettes, numbered as 60, 65, 70, 75, 80 and 85 are shown for general reference in FIGS. 11-16.

### Composition

Briquette 10 comprises a core portion 24 and an accelerant-impregnated portion 26, as shown in FIG. 4. Core portion 24 may be comprised of any conventional combustible material available in the art including, without limitation, materials such as wood charcoal, anthracite coal, light calcium carbonate and liquid corn starch, separately or in various combinations and proportions as may be suitable for a particular application. Accelerant portion 26 may be comprised of any conventional accelerant material available in the art including, without limitation, wood charcoal, light calcium carbonate, liquid corn starch, stearic acid, terebinth, stearate-sort, vegetable oil, animal fat oil, paraffin, olefin, solid alcohol and solid ethanol, vegetable-sort oil, liquid ketone, liquid alkyl, liquid alcohol, liquid ethanol, pine cone oil, oil of turpentine and turpentine, separately or in various combinations and proportions as may be suitable for a particular application. The components of core portion 24 and accelerant portion 26 are preferably natural, organic-based materials lacking in nitrates or other similar chemicals known to be harmful to humans and the environment, that do not impart any undesired flavors into food cooked by the fabricated briquette.

### Fabrication

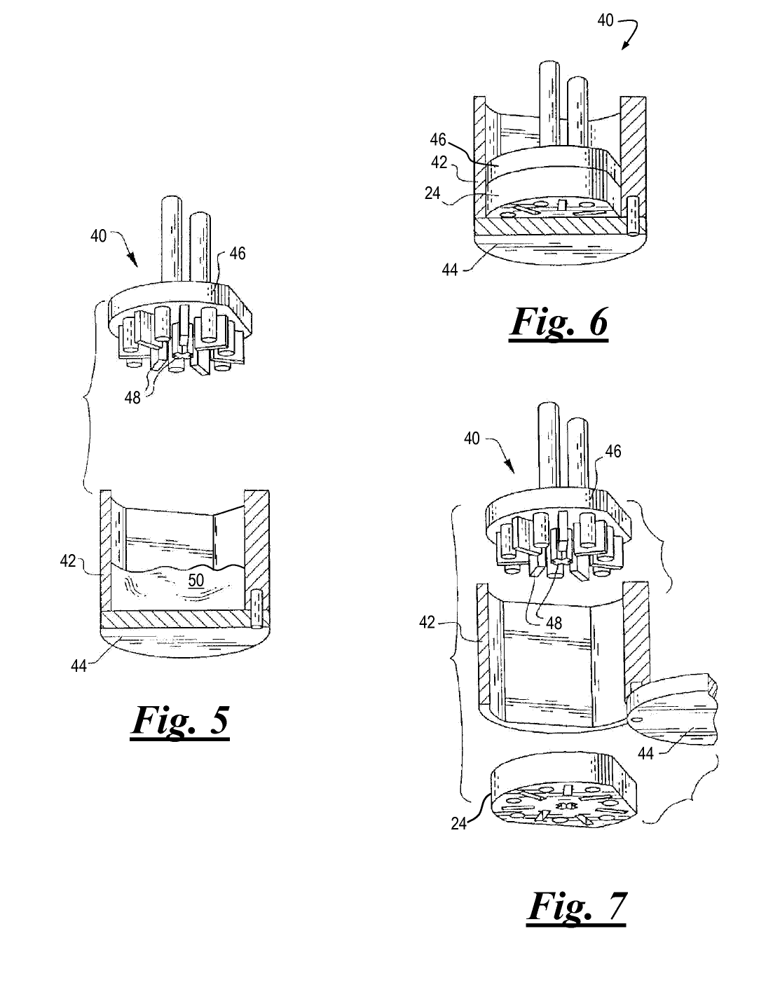

Core portion 24 of briquette 10 may be formed using any conventional process including, without limitation, molding, stamping and machining. A non-limiting example molding process is shown in FIGS. 5-7. A molding device 40 is made from a material, such as steel, that is compatible with core portion 24 and has good wear resistance and low distortion. Molding device 40 includes a sleeve 42, to which is attached a base plate 44, preferably a solid plate. Base plate 44 is attached by a pivot to one end of sleeve 42 such that the base plate pivots outwardly from the sleeve, but in the same plane as the opening in the sleeve. At the other end of sleeve 42 is oriented a piston 46 having shaped rods 48. Rods 48 preferably form and define the vents 14, 16, 18 in briquette 10 (see FIGS. 1-4).

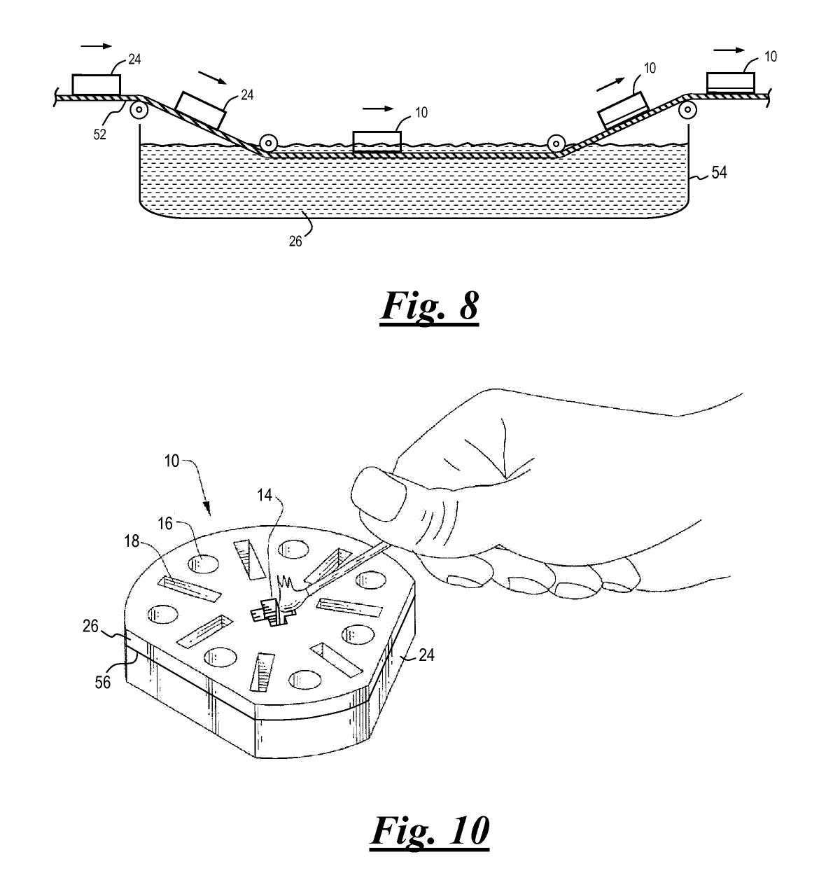

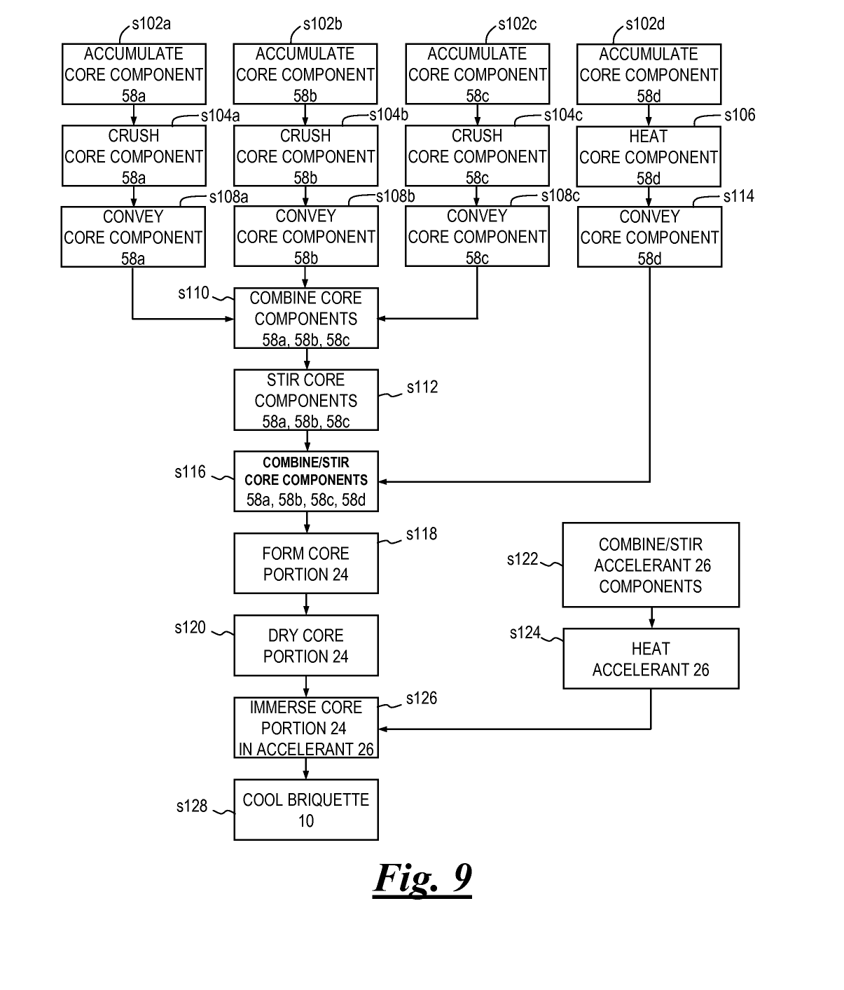

To produce a briquette, molding device 40 is loaded as shown in FIG. 5 with a wet mixture 50 having the composition of the core portion 24. Mixture 50 is then compacted with piston 46, as shown in FIG. 6. The rods 48 of piston 46 extend through mixture 50 to form vents 14, 16, 18 in core portion 24, the shapes of the vents corresponding to the various shapes of rods 48. The compacted and shaped core portion 24 is then ejected as shown in FIG. 7 through the end opposite of piston 46, the exit path created by pivoting base plate 44 outwardly from sleeve 42.

With reference to FIGS. 4 and 8 in combination, an example method for combining accelerant portion 26 with core portion 24 will now be described. A compacted and shaped core portion 24, which may be cool, warm or hot according to particular application, is placed onto a conveyor belt 52, which transports the core portion into an immersion tank 54 containing a heated, liquefied compound of accelerant 26. Core portion 24 is at least partially submerged in accelerant portion 26 to a predetermined depth, such as about 1-2 cm, for a predetermined soaking time, such as about 5-10 seconds, so that the submerged portion absorbs and/or is coated with the accelerant portion to form a briquette 10. Lesser or greater depths may be selected for alternate applications, within the scope of the invention. The soaking time may be established by the speed of conveyor belt 52 and/or a period of dwell time wherein the conveyor belt is slowed or stopped. After soaking in accelerant 26 for the predetermined amount of time the completed briquette 10 is transported out of immersion tank 54 by conveyor belt 40 for cooling.

The method of FIG. 8 illustrates only one of several ways accelerant portion 26 may be combined with core portion 24. For example, in other embodiments of the present invention one or more core portions 24 may be dipped in accelerant portion 26 to a predetermined depth for a predetermined dwell time. Dipping of core portion 24 in accelerant portion 26 may be accomplished either manually or through the use of automated material handling equipment, such as robotic equipment configured accordingly. In addition, core portion 24 may be dipped in accelerant portion 26 either individually or in a group, such as a plurality of core portions placed into a mesh container in a single layer.

With reference to FIGS. 1, 4 and 10, a line 56 is shown as a delineator between accelerant portion 26 and core portion 24 for illustrative purposes. Line 56 represents a demarcation in any or all of color, texture and glossiness (among other characteristics) between accelerant portion 26 and core portion 24, but is not necessarily a discrete or well-defined boundary line. In some embodiments of the present invention line 56 may also be non-linear, i.e. undulating.

Conveyor belt 52 may be made from any material suitable for use with core portion 24 and accelerant 26. In one embodiment conveyor belt 52 is made from steel mesh material. Conveyor belt 52 is preferably a continuous or “endless loop” belt.

Immersion tank 54 may be made from any material suitable for use with accelerant 26. Immersion tank 54 is configured to heat and maintain accelerant 26 at a predetermined temperature. Immersion tank 54 may be directly heated with heating elements, or may be heated indirectly by a water hot water tank in proximity thereto. Both heating methods are well-known in the art and thus will not be detailed further.

### Process

A flow diagram showing an example process for producing briquette 10 is shown in FIG. 9. At steps s102a-s102d core portion 24 components, shown generally as 58a, 58b, 58c and 58d, are separately accumulated using any conventional process such as, without limitation, storage in heaping yards, containers and buildings.

At steps s104a-s104c solid components 58a, 58b, 58c of core portion 24 are separately granulated, such as by crushing, using any conventional process such that the components are reduced to a granular form having a predetermined granule range of granule sizes. For wood charcoal and anthracite coal a granule size of about 100 mesh is desirable. Example processes include crushing and/or sifting the components to achieve the desired granule size. Air flow across a crushing and/or sifting process may also be utilized to aid in gathering crushed materials having small granularity.

At step s106 one or more core portion 24 liquid components, shown generally as 58d in FIG. 9, may be separately heated to a predetermined temperature, forming a liquid. Core portion component 58d may be heated in a container, such as a steel tank, a pressurized and heated pipe, a heated helix auger, or a combination thereof.

At steps s108a-s108c the granulated core portion components 58a, 58b, 58c of steps s104a-s104c are separately conveyed for combination in a common container or vessel, as at s110. Example conveyances include, without limitation, conveyor belts, material augers, pipes, funnels or any combination thereof. The conveyances of s108a-s108c may include pressurization, mechanical agitators and/or timed- or phased-operation of high-pressure gas jets within the conveyances to resist clumping or jamming of core portion components, thereby aiding accurate and repeatable dispensing of the core portion components in the desired amounts and proportions at step s110, below.

At step s110 core portion components 58a, 58b, 58c are metered into a common container in predetermined proportions suitable for a given application. The core portion components may be metered manually by measuring out components in the desired proportions to produce a batch of a predetermined quantity of briquettes 10. Alternatively, the core portion components may be automatically dispensed, measured and metered using conventional computer-controlled material-handling equipment and devices.

At step s112 the combined core portion 24 components 58a, 58b, 58c are stirred as needed to achieve a generally uniform or homogenous dry combination. The core portion components may be stirred together in a container by any conventional process including, without limitation, conventional agitators, beaters and paddles. In some embodiments of the present invention helix-screw augers may be used to transport the combined core portion components while simultaneously stirring them. In still other embodiments the combined core portion components may be subjected to plural parallel and/or serially staged stirring processes utilizing containers and/or augers during step s112 to ensure uniformity.

At step s114 heated and liquefied core portion component 58d is conveyed for combination with the previously-combined dry mixture of core portion components 58a, 58b, 58c to form a wet mixture 50 (FIG. 5). Any conveyance suitable for transporting heated liquids may be used for step s114 such as, without limitation, piping, tubing, helix augers and troughs. The proper quantity of core portion component 58d may be metered manually by measuring out a predetermined proportion of component 58d in relation to the combined components 58a, 58b, 58c. Alternatively, core portion component 58d may be automatically dispensed, measured and metered using conventional computer-controlled material-handling equipment and devices.

Mixture 50 may formed at s116 by any conventional process such as combining the solid combination of core portion components 58a, 58b, 58c and heated liquid core component 58d in a common container or vessel and stirring with conventional stirrers, beaters, paddles or agitators. Alternatively, core portion components 58a, 58b, 58c and heated core portion component 58d may be both combined and stirred together while being transported, such as through the use of helix-screw augers. When formed, mixture 50 (FIG. 5) may have the consistency of a wet mixture comprising solid materials.

At step s118 a core portion 24 is formed using the process of FIGS. 5-7 and the accompanying text. However, it should be noted that core portion 24 may be formed using any suitable alternate conventional process including, without limitation, molding, stamping and machining.

At step s120 core portion 24 is dried by any conventional process including, without limitation, kilns or ovens incorporating any combination of heat, infra-red energy, blowing air and vacuum. Humidity controls may also utilized to control the drying of core portion 24. In one embodiment of the present invention the core portions 24 are loaded into drying trays, which are put into a kiln for drying. The kiln is preferably tunnel-shaped and typically extends approximately 40 to 50 meters. The entrance temperature of this kiln is approximately 150 degrees Centigrade, and heated air in the kiln should be provided with relatively low humidity. These conditions are maintained for about 6.5 to 7 hours, at which time the core portions 24 are removed. The exit temperature of the kiln is about 50 to 60 degrees Centigrade at a relatively high humidity.

At step s122 the components of accelerant 26 are compounded together, then heated to a predetermined temperature to achieve and sustain a liquefied state as at s124. Accelerant portion 26 has a predetermined viscosity corresponding to the desired extent to which the accelerant portion is to penetrate core portion 24 when combined therewith. A kettle (not shown) may be used to stir and heat the components of accelerant 26 to a liquid state. In one embodiment the kettle has three layers. The interior layer is made of a porcelain enamel material. The middle layer at least partially includes an oil to aid in heat conduction, and the outer layer is made of steel. The kettle may include conventional stirring paddles, beaters, agitators or similar devices to aid in mixing the components of accelerant 26.

At step s126 the dried core portion 24, which may be cool, warm or hot according to particular application, is at least partially immersed, i.e., submerged, in the liquefied accelerant 26, as depicted in FIG. 8 and described in the text accompanying the figure such that the core portion is at least partially coated by the accelerant and/or the core portion absorbs a quantity of the accelerant. An example proportion of core portion and accelerant portion is about 5:2, although a greater or lesser proportion may be selected, if desired, for a particular application. The finished briquette 10 may optionally be cooled at s128 by any conventional means including, without limitation, air cooling, forced air, refrigeration and vacuum cooling.

The finished briquette 10 may then packaged for storage and/or shipment. For example, one or more briquettes 10 may be encased separately or together in a protective layer, such as a plastic shrink wrap or vacuum sealing. Furthermore, a quantity of briquettes 10 may be packaged together in a container, such as a paperboard container.

In use, a group of briquettes 10 may be placed adjacent each other such that the sidewalls 12 of each briquette are proximate the sidewalls of adjacent briquettes. In one embodiment the sidewalls 12, when extrapolated, form an included angle of approximately 30 degrees. This angle permits orientation of six briquettes to define a circle about a center portion which is free of the cooking medium. The center portion of the circle formed by a group of six briquettes 10 is the optimal area for cooking. Cooking directly over the briquettes 10 subjects the barbecued item to greater heat overall, which leads to greater cooking control when using briquette of the present invention.

Accelerant portion 26 serves to ignite the core portion 24 of each briquette 10. When the accelerant portion 26 is applied in accordance with FIG. 8, some of the accelerant flows into the vents 14, 16, 18 (FIGS. 1-4). The degree to which the inside surfaces are coated is directly related to the viscosity of the accelerant mixture. The above-described process produces zones of designated accelerated heating, which include the accelerant-covered surface, 20, the profile of each of the vents 14-18 in the accelerant-covered surface, and the circumscribing peripheral walls of briquette 10. The centrally-located cruciform-shaped vent 14 provides a surface that is particularly conducive to ignition. Ignition at the centrally-located cruciform-shaped vent 14 is preferable due to the increased surface area provided by the several corners defined inside the vent. These areas are highly conducive to ignition, having a large surface area relative to its size. After ignition at the center (FIG. 10), burning of accelerant portion 26 continues radially outward due to the substantially even coating of the accelerant provided by the method of the present invention. When the burning contacts the peripheral vents 16, 18, a similar phenomenon occurs, providing uniform burning by virtue of the substantially even spacing of the vents. Because all of the vents 16, 18 extend through the entire briquette 10, enhanced airflow is provided, encouraging generally even top-to-bottom burning of the briquette.

In some embodiments of the present invention a fuse (not shown) may be joined with accelerant portion 26 to further facilitate lighting of briquette 10. One example is a fuse formed as a substantially circular disc of fibrous material and attached to accelerant portion 26, as described in applicant's U.S. Pat. No. 7,022,147 and incorporated herein by reference. Other example fuses include wicks, tabs and pads joined with accelerant portion 26 and made of a material suitable for sustaining a flame sufficient to ignite the accelerant portion.

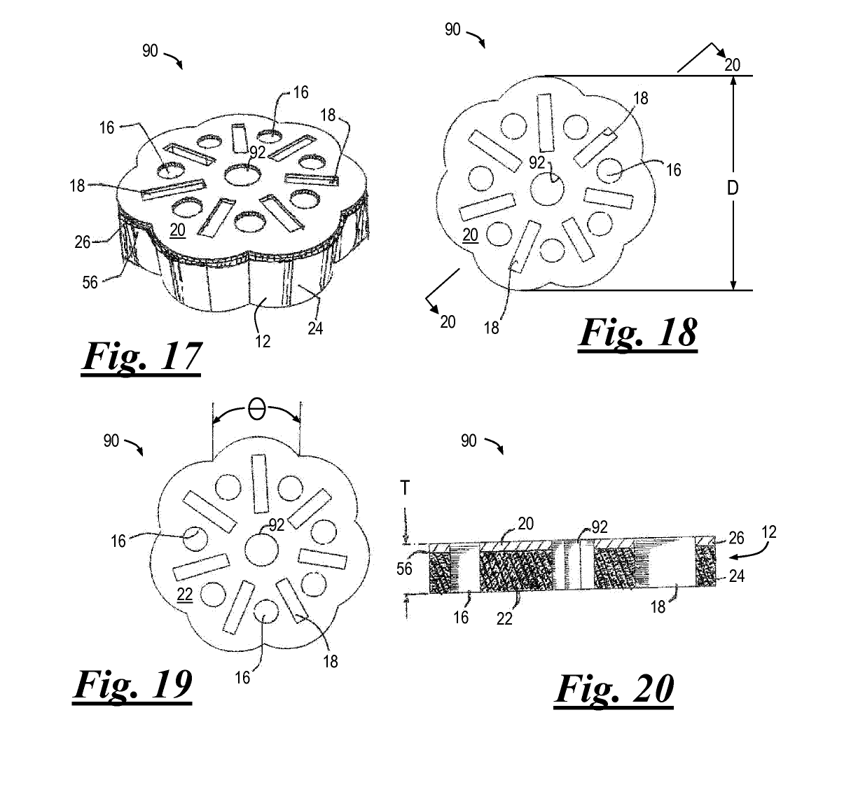

With reference to FIGS. 17-20 in combination, the general arrangement of a briquette 90 having a plurality of facets to form a generally round “plum blossom” shape is shown according to an embodiment of the present invention. In one embodiment briquette 90 is generally planar, has a predetermined thickness “T” of about 3-5 cm, and a predetermined diameter “D” of about 12 cm with petals having an angle θ, the petals having sides 12. However, it should be noted that any or all of diameter D, thickness T and angle θ may be varied as desired for a particular configuration of briquette 90 without departing from the scope of the present invention.

Briquette 90 may further include a generally centrally-located cylindrical vent 92, as well as a plurality of peripherally-located, cylindrically-shaped vents 16 and rectangularly-shaped vents 18. Vents 16, 18, 92 extend between a top surface 20 and a bottom surface 22 of briquette 90. Vents 16, 18, 92 encourage air flow ventilation through and around briquette 90 for rapid, even burning and complete combustion, thus providing a clean, low-ash heat source. Vents 16, 18, 92 also provide for fast and generally uniform drying of briquette 90 during fabrication of the briquette, as further detailed below.

With continued reference to FIGS. 17-20, in one example embodiment of the present invention cylindrical vent 92 is centrally located. Peripheral cylindrical vents 16 (having a diameter of about 12-15 mm) and peripheral elongated slot vents 18 (having dimensions of about 6-8 cm in length and about 3-4 cm in width) are arranged in an alternating pattern, extending radially outward from the central aperture 92. The size, shape, number and locations of each of vents 16, 18, 92 may be varied as desired to form a predetermined pattern for a particular configuration of briquette 90. The remaining features, such as core portion 24, accelerant portion 26 and line 56 are as previously detailed and thus will not be reiterated here.

In some embodiments of the present invention seasoning materials may be added to briquette 10, such as a core component 58, to produce a desired aroma and/or impart flavoring to food cooked over the briquette. For example, seasoning materials may be added to briquette 10 to add a smokehouse, hickory, fruitwoods or mesquite flavoring and/or aroma. Non-limiting example seasoning materials include wood shavings or chips, resins, oils and extracts.

In still other embodiments of the present invention the proportions of the components of core portion 24 and accelerant portion 26, may be varied in order to tailor the burning characteristics of the accelerant portion in a desired manner, such as achieving a relatively fast combustion rate and/or intensity. Likewise, the proportions of the components of core portion 24 and accelerant portion 26 may be varied within the ranges specified (or even beyond the specified ranges) in order to achieve a greater or lesser amount of smoke generated by the core portion and/or the accelerant portion while combusting.

While this invention has been shown and described with respect to a detailed embodiment thereof, it will be understood by those skilled in the art that changes in form and detail thereof may be made without departing from the scope of the claims of the invention.

What is claimed is:

1. A method for making a combustible fuel composition, comprising the steps of:
granulating at least one core component to a predetermined range of granule sizes;
forming a metered portion of the granulated core component into a generally planar core portion having a predetermined size and shape;
providing a liquefied accelerant component; and
at least partially immersing the core portion into the accelerant component such that the accelerant component at least one of coats the core portion and is absorbed by the core portion, thereby forming a briquette.

2. The method of claim 1, further comprising the steps of:
granulating a plurality of core components to respective predetermined ranges of granule sizes,
combining the granulated core components together, and
stirring the combined core components before forming them into a core portion.

3. The method of claim 1, further comprising the steps of:
combining a liquefied core component together with a solid core component, and
stirring the combined core components before forming them into a core portion.

4. The method of claim 3, further comprising the step of heating the liquefied core component before combining it together with the solid core component.

5. The method of claim 3, further comprising the step of drying the core portion after forming.

6. The method of claim 1 wherein the core portion is formed by one or more of molding, stamping and machining the metered portion of the core component.

7. The method of claim 1, further comprising the step of cooling the briquette.

8. The method of claim 1 wherein the core portion is at least partially immersed in the accelerant component by being transported by means of a conveyor belt into an immersion tank containing the liquefied accelerant and submerged in the accelerant to a predetermined depth for a predetermined soaking time, then transported out of the tank by the conveyor belt.

9. The method of claim 1 wherein the core portion is at least partially immersed in the accelerant component by being dipped into an immersion tank containing the liquefied accelerant and submerged in the accelerant to a predetermined depth for a predetermined soaking time, then removed from the immersion tank.

10. The method of claim 1, further comprising the step of forming the core portion into one of a plum blossom, circular, square, polygonal, trapezoidal, hexagonal, pentagonal, triangular and octagonal shape.

11. The method of claim 1, further comprising the step of forming at least one vent in the core portion.

12. The method of claim 1, further comprising the step of forming the vent in at least one of a cruciform, circular and slot-shape.

13. The method of claim 11, further comprising the step of forming a plurality of vents in the core component, the vents having predetermined shaped and a predetermined pattern.

14. The method of claim 1, further comprising the step of encasing the briquette in a protective layer.

15. A method for making a combustible fuel composition, comprising the steps of:
granulating a plurality of solid core components to respective predetermined ranges of granule sizes;
combining the granulated solid core components together;
stirring the combined solid core components;
combining a liquefied core component together with the combined solid core components;
stirring the combined solid and liquid core components;
forming a metered portion of the combined solid and liquid core components into a generally planar core portion having a predetermined size and shape;
providing a liquefied accelerant component; and
at least partially immersing the core portion into the accelerant component such that the accelerant component at least one of coats the core portion and is absorbed by the core portion, thereby forming a briquette.

16. The method of claim 15 wherein the core portion is at least partially immersed in the accelerant component by being transported by means of a conveyor belt into an immersion tank containing the liquefied accelerant and submerged in the accelerant to a predetermined depth for a predetermined soaking time, then transported out of the tank by the conveyor belt.

17. The method of claim 15 wherein the core portion is at least partially immersed in the accelerant component by being dipped into an immersion tank containing the liquefied accelerant and submerged in the accelerant to a predetermined depth for a predetermined soaking time, then removed from the immersion tank.

18. The method of claim 15, further comprising the step of forming at least one vent in the core portion.

19. The method of claim 15, further comprising the step of encasing the briquette in a protective layer.

20. A method for making a combustible fuel composition, comprising the steps of:
granulating a plurality of solid core components to respective predetermined ranges of granule sizes;
combining the granulated solid core components together;
stirring the combined solid core components;
combining a liquefied core component together with the combined solid core components;
stirring the combined solid and liquid core components;
forming a metered portion of the combined solid and liquid core components into a generally planar core portion having a predetermined size and shape;
drying the core portion after forming;
providing a liquefied accelerant component in an immersion tank;
transporting the core portion into the immersion tank by means of a conveyor belt;
at least partially immersing the core portion in the accelerant component at a predetermined depth for a predetermined soaking time such that the accelerant component at least one of coats the core portion and is absorbed by the core portion, thereby forming a briquette;
transporting the briquette out of the immersion tank by means of the conveyor belt; and
cooling the briquette.

21. The method of claim 20, further comprising the step of forming the core portion into one of a plum blossom, circular, square, polygonal, trapezoidal, hexagonal, pentagonal, triangular and octagonal shape.

22. The method of claim 20, further comprising the step of forming at least one vent in the core portion.

23. The method of claim 20, further comprising the step of encasing the briquette in a protective layer.
